(19) United States
(12) Patent Application Publication
(10) Pub. No.: US 2024/0430619 A1
(43) Pub. Date: Dec. 26, 2024

(54) MICRO-SPEAKER DEVICE

(71) Applicant: Vanson Electronics (Nanhai) Co., Ltd., Foshan City (CN)

(72) Inventor: Hao-Chien Hsu, Taipei City (TW)

(21) Appl. No.: 18/757,464

(22) Filed: Jun. 27, 2024

Related U.S. Application Data
(63) Continuation-in-part of application No. 18/432,095, filed on Feb. 5, 2024.

(30) Foreign Application Priority Data
Jun. 20, 2023 (CN) 202310740937.1
Aug. 9, 2023 (CN) 202311003276.0

(51) Int. Cl. H04R 7/04; H04R 9/04

(52) U.S. Cl. CPC H04R 7/04; H04R 9/043; H04R 9/046

(57) ABSTRACT

The invention discloses a micro-speaker device including a frame, and a drum paper having a diaphragm and a surround. The diaphragm is flexibly connected to one end of the frame through the surround, thereby forming a first suspension system. A magnetic circuit structure includes a main magnetic portion and a yoke surrounding the main magnetic portion. A magnetic gap is provided between the main magnetic portion and a folded portion of the yoke. A voice coil is sleeved on an outer periphery of the main magnetic portion and penetrates into the magnetic gap. One end of the voice coil is fixed to the diaphragm. Two dampers flexibly connect the bottom of the voice coil and the bottom surface of the frame. A one-piece elastic member flexibly connects the first surface of the bottom of the yoke and the bottom surface of the frame to form a second suspension system.

### CROSS REFERENCE TO RELATED APPLICATIONS

This application is a continuation-in-part of U.S. application Ser. No. 18/432,095, filed on Feb. 5, 2024. The content of the application is incorporated herein by reference.

### BACKGROUND OF THE INVENTION

### 1. Field of the Invention

The invention relates to the technical field of acoustic devices, in particular to a micro-speaker device having a dual suspension system.

### 2. Description of the Prior Art

A loudspeaker is a kind of transducer element that converts electrical signals into acoustic signals, and is an important acoustic component in electronic products. The micro-speaker module usually includes a frame and a magnetic system and a vibration system disposed within the frame. The vibration system includes a diaphragm and a voice coil arranged under the diaphragm. The voice coil drives the diaphragm to produce sound under the vibration of the magnetic system.

However, the vibration of the speaker diaphragm may be transmitted to the electronic product, and generate noise. Since the internal space of electronic products is very limited, how to design an effective vibration-absorbing structure on a speaker unit has become a major challenge in this technical field.

### SUMMARY OF THE INVENTION

It is one object of the present invention to provide an improved micro-speaker device with a dual suspension system to solve the problems raised in the background art above.

One aspect of the invention provides a micro-speaker device including a frame; a drum paper comprising a diaphragm and a surround, and the diaphragm is flexibly connected to one end of the frame via the surround, thereby forming a first suspension system; a magnetic structure comprising a main magnetic portion and a yoke covering and surrounding the main magnetic portion, wherein a magnetic gap is provided between the main magnetic portion and a folded portion of the yoke; a voice coil sleeved on an outer periphery of the main magnetic portion and penetrates into the magnetic gap, wherein one end of the voice coil is fixedly connected to the diaphragm; at least one damper flexibly connecting a bottom of the voice coil and a bottom surface of the frame; and a one-piece elastic member flexibly connected to a first surface of a bottom of the yoke and the bottom surface of the frame, thereby forming a second suspension system.

According to some embodiments, the at least one damper comprises a first end, a second end and a cantilever connecting the first end and the second end.

According to some embodiments, a ratio (L/D) of cantilever length L to cantilever distribution distance D is between 2 and 15.

According to some embodiments, a voice coil lead is fixed to a welding portion of the first end of the at least one damper through electronic spot welding and is electrically connected to circuit on the at least one damper and connection terminals on the second end of the at least one damper.

According to some embodiments, the yoke has a central opening.

According to some embodiments, the central opening is a long and narrow through hole extending along a long axis direction of the yoke, and the central opening penetrates through an entire thickness of the yoke.

According to some embodiments, an elastic material is provided in the central opening.

According to some embodiments, the elastic material comprises foam or rubber.

According to some embodiments, one end of the central opening is covered by the main magnetic portion fixed on the yoke.

According to some embodiments, no openings are provided at the bottom of the yoke.

According to some embodiments, the first surface is coplanar with the bottom surface of the frame.

According to some embodiments, a width of the one-piece elastic member is greater than a width of the surround.

According to some embodiments, the one-piece elastic member is an integrally formed structure.

According to some embodiments, the one-piece elastic member is an annular structure.

According to some embodiments, the one-piece elastic member is a continuous annular structure.

According to some embodiments, the one-piece elastic member is a discontinuous annular structure.

According to some embodiments, the one-piece elastic member is composed of a metal sheet, a plastic sheet, a rubber sheet or a paper sheet.

According to some embodiments, the one-piece elastic member comprises an inner ring structure, an outer ring structure, and a cantilever connecting the inner ring structure and the outer ring structure.

According to some embodiments, the inner ring structure is directly connected and fixed to a periphery of the first surface.

According to some embodiments, the main magnetic portion is fixed on a second surface of the bottom of the yoke opposite to the first surface.

According to some embodiments, an annular recessed structure is provided around the bottom of the yoke to form an annular third surface of the bottom, which is lower than the first surface, thereby providing a buffer space between the annular recessed structure and the one-piece elastic member.

According to some embodiments, the outer ring structure is provided with a positioning recess, and corresponding to the positioning recess, the frame is further provided with a positioning protrusion to facilitate the positioning during assembly.

According to some embodiments, a linear distance between relative joints of the cantilever between the inner ring structure and the outer ring structure is d, and an actual length between the relative joints of the cantilever between the inner ring structure and the outer ring structure is 1, wherein l/d is about 1 to 3.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a front side view of a micro-speaker device according to an embodiment of the present invention.

FIG. 2 is a back side view of a micro-speaker device according to an embodiment of the present invention.

FIG. 3 is an exploded view of the micro-speaker in FIG. 1.

FIG. 4 is a schematic cross-sectional view of the micro-speaker device taken along line I-I′ in FIG. 2.

FIG. 5 is a schematic cross-sectional view of the micro-speaker device taken along line II-II′ in FIG. 2.

FIG. 6 shows the length, width and distribution distance of the cantilever of the damper.

### DETAILED DESCRIPTION

In order to make the objectives, technical solutions, and advantages of the embodiments of the present invention clearer, the technical solutions in the embodiments of the present invention will be described clearly and completely in conjunction with the accompanying drawings in the embodiments of the present invention. Obviously, the described embodiments are part of the embodiments of the present invention, but not all of the embodiments. Based on the embodiments of the present invention, all other embodiments obtained by those of ordinary skill in the art without creative work shall fall within the protection scope of the present invention. Therefore, the following detailed description of the embodiments of the present invention provided in the accompanying drawings is not intended to limit the scope of the claimed invention, but merely represents selected embodiments of the present invention.

In the description of the present invention, it should be understood that the terms “center”, “longitudinal”, “transverse”, “length”, “width”, “thickness”, ‘upper”, “lower”, “front’, “back”, “left”, “right”, “vertical”, “horizontal”, ‘top’, “bottom”, “inside”, “outside”, “clockwise”, “counterclockwise” and other directions or the positional relationship are based on the orientation or positional relationship shown in the drawings, and is only for the convenience of describing the present invention and simplifying the description, and does not indicate or imply that the pointed device or element must have a specific orientation, be constructed and operated in a specific orientation, Therefore, it shall not be interpreted as a limitation to the present invention.

In the present invention, unless otherwise expressly provided and limited, the term a first feature “above” or “below” a second feature may include the situation that the first and second features being in direct contact, or that the first and second features not in direct contact but through additional feature contact between them. Furthermore, the term: a first feature “over”, “above” or “on” a second feature includes the situation that the first feature being directly above and diagonally above the second feature, or simply mean that the first feature is higher in level than the second feature. The term: a first feature “under”, “below” and “underneath” a second feature includes the situation that the first feature being directly below and diagonally below the second feature, or simply means that the first feature is lower in level than the second feature.

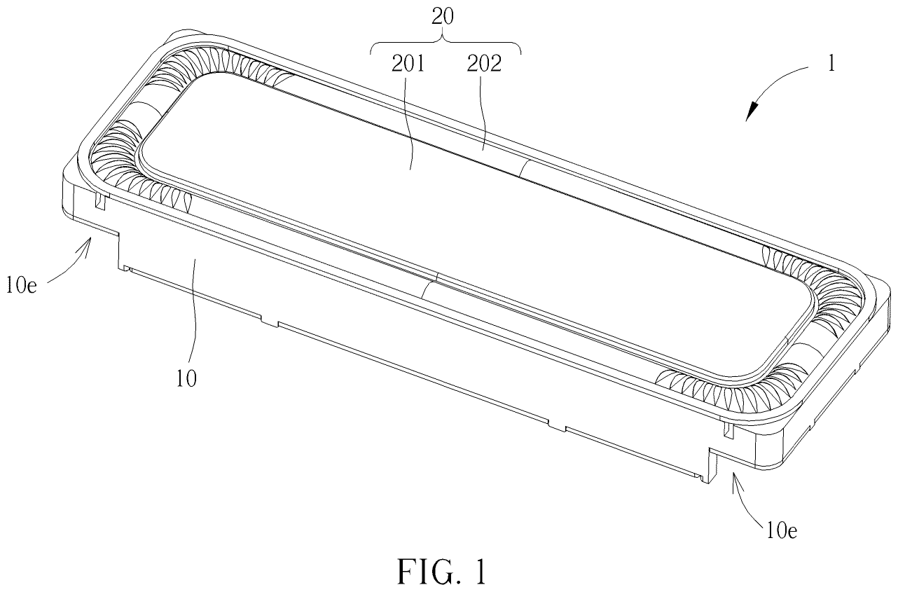

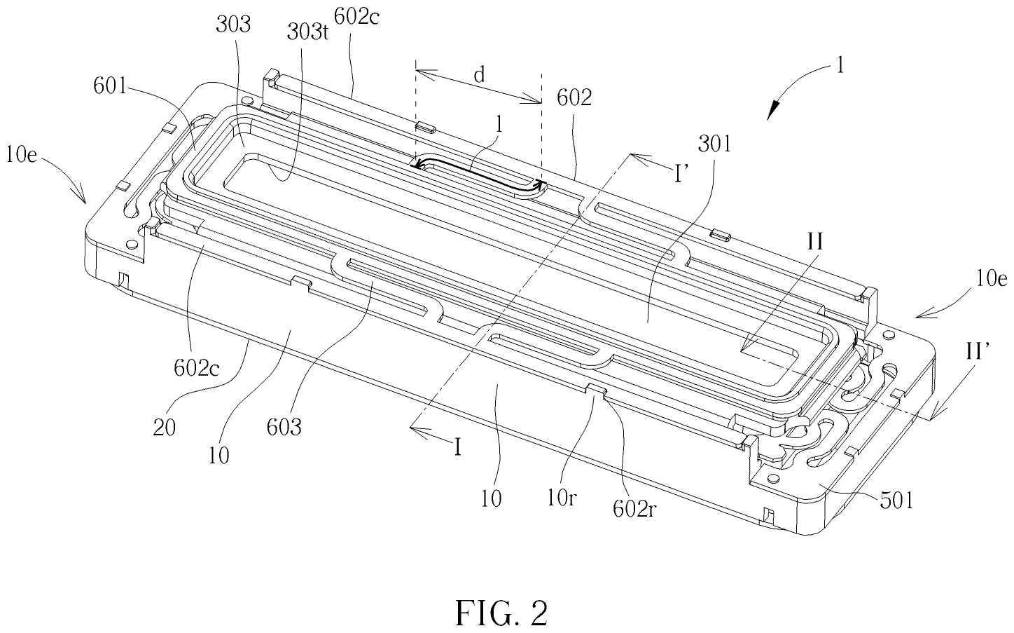

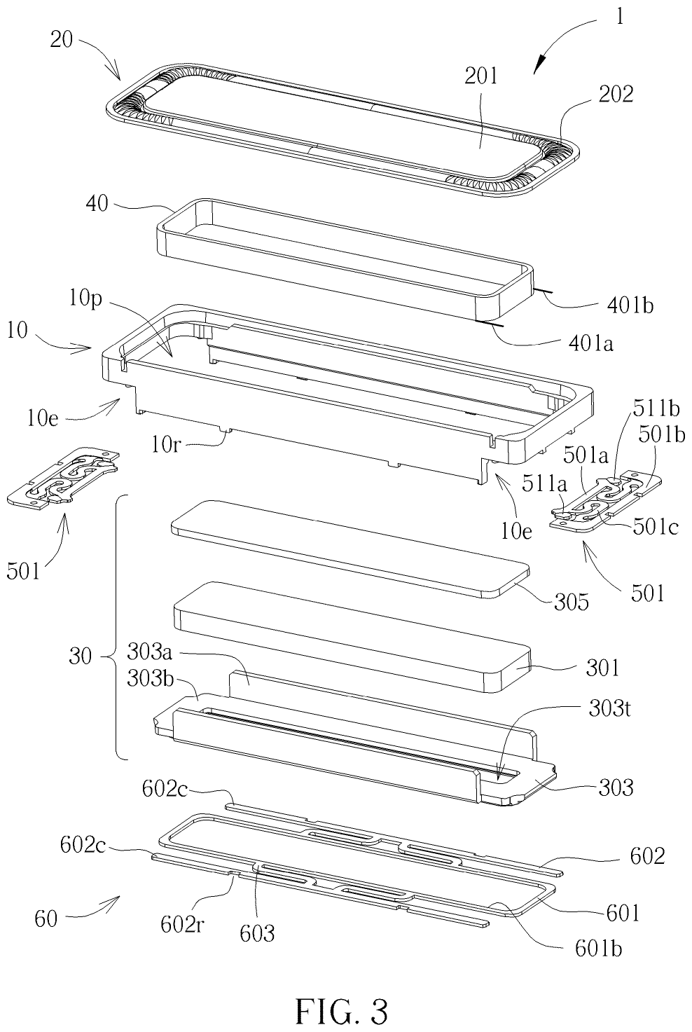

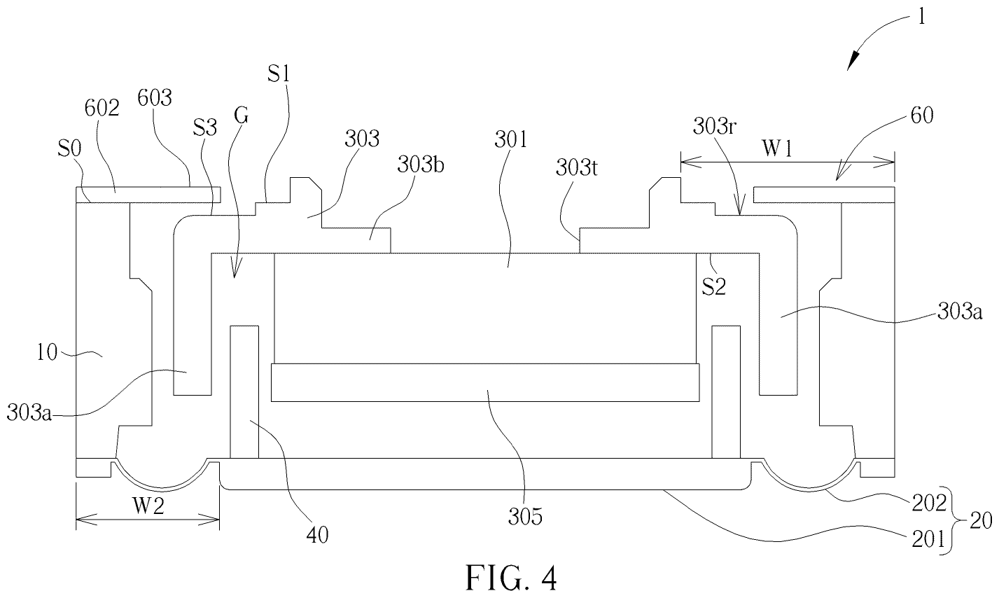

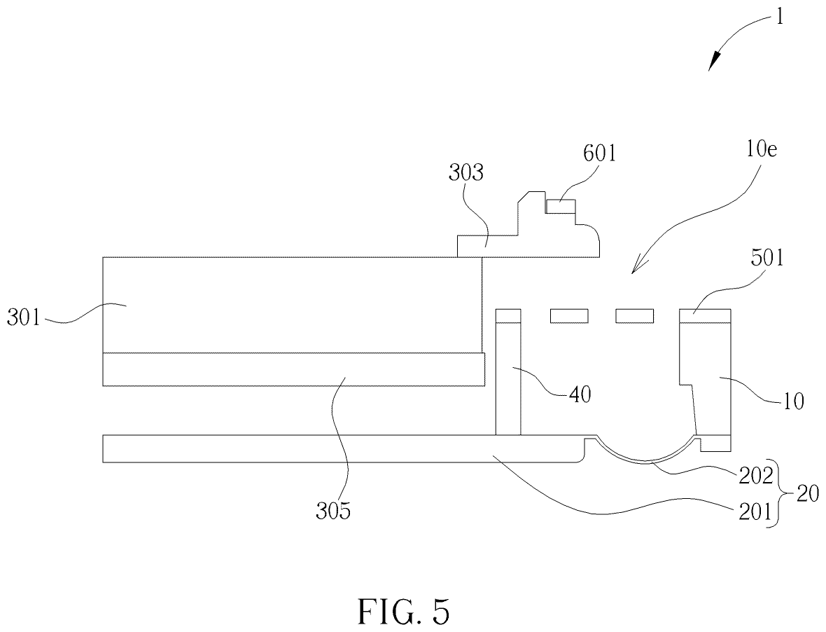

Please refer to FIG. 1 to FIG. 5. FIG. 1 is a front side view of a micro-speaker device according to an embodiment of the present invention. FIG. 2 is a back side view of a micro-speaker device according to an embodiment of the present invention. FIG. 3 is an exploded view of the micro-speaker device in FIG. 1. FIG. 4 is a schematic cross-sectional view of the micro-speaker device taken along line I-I′ in FIG. 2. FIG. 5 is a schematic cross-sectional view of the micro-speaker device taken along line II-II′ in FIG. 2.

As shown in FIG. 1 to FIG. 5, the micro-speaker device 1 includes a frame 10 and drum paper 20 disposed on the frame 10. According to an embodiment of the present invention, the drum paper 20 may include a diaphragm 201 and a surround 202 around the diaphragm 201. The surround 202 may have an arc-shaped or wave-like cross-section. According to an embodiment of the present invention, the diaphragm 201 and the surround 202 may be made of different materials, but not limited thereto.

According to an embodiment of the present invention, preferably, the diaphragm 201 of the drum paper 20 is flexibly connected to one end of the frame 10 via the surround 202. According to an embodiment of the present invention, the diaphragm 201 is arranged in an elongated shape, that is, its dimension in the lengthwise direction is larger than its dimension in the widthwise direction. According to an embodiment of the present invention, the frame 10 has an opening 10p adapted to the shape of the drum paper 20 and the diaphragm 201, and the diaphragm 201 is connected to the frame 10 through the annular surround 202 to seal the opening 10p, thereby forming a first suspension system at one end of the frame 10. Recessed portions 10e are disposed at two opposite ends in the lengthwise direction of the frame 10.

According to an embodiment of the present invention, a magnetic structure 30 is provided in the frame 10, including a main magnetic portion 301, a yoke 303 covering and surrounding the main magnetic portion 301, and a washer 305 arranged on the main magnetic portion 301 for magnetic conduction. According to an embodiment of the present invention, the main magnetic portion 301 is fixed on the yoke 303. According to an embodiment of the present invention, as shown in FIG. 4, a magnetic gap G is provided between the main magnetic portion 301 and the folded portion 303a of the yoke 303.

According to an embodiment of the present invention, a voice coil 40 is disposed in the frame 10. According to an embodiment of the present invention, the voice coil 40 is formed by winding an enameled wire alone, and a bobbin is not required. The voice coil 40 is sleeved on the outer periphery of the main magnetic portion 301 and is extended into the magnetic gap G along a vertical direction. According to an embodiment of the present invention, the voice coil 40 is set in an elongated shape, that is, the size in the lengthwise direction is larger than the size in the widthwise direction, and the upper end of the voice coil 40 is fixedly connected to the diaphragm 201. Preferably, in some embodiments of the present invention, the center of the voice coil 40 is located on the central axis in the lengthwise direction of the diaphragm 201. A magnetic field is provided through the magnetic structure 30 to make the voice coil 40 vibrate, and the diaphragm 201 is driven to produce sound.

According to an embodiment of the present invention, as shown in FIG. 2, FIG. 3 and FIG. 5, two symmetrically arranged dampers 501 are disposed in the frame 10. According to an embodiment of the present invention, the two dampers 501 are disposed in the recessed portions 10e at both ends of the long axis of the voice coil 40, and may be fixed with glue, for example. According to an embodiment of the present invention, the dampers 501 are composed of a flexible printed circuit (FPC).

According to an embodiment of the present invention, as shown in FIG. 2, the damper 501 includes a first end 501a, a second end 501b, and a cantilever 501c connecting the first end 501a and the second end 501b. A hollow portion is disposed between the first end 501a, the second end 501b and the cantilever 501c. The first ends 501a of the dampers 501 are respectively fixed under the two ends of the long axis of the voice coil 40 with glue, and the second ends 501b of the dampers 501 are respectively fixed to the recessed portions 10e at the two ends of the long axis of the frame 10. The voice coil leads 401a and 401b are respectively fixedly connected to the welding portions 511a and 511b of the first end 501a of the front surface of the damper 501 through electronic spot welding, and are electrically connected to the circuit on the bottom surface of the damper 501, and is further electrically connected to the connection terminal on the bottom surface of the second end 501b through the circuit on the damper 501.

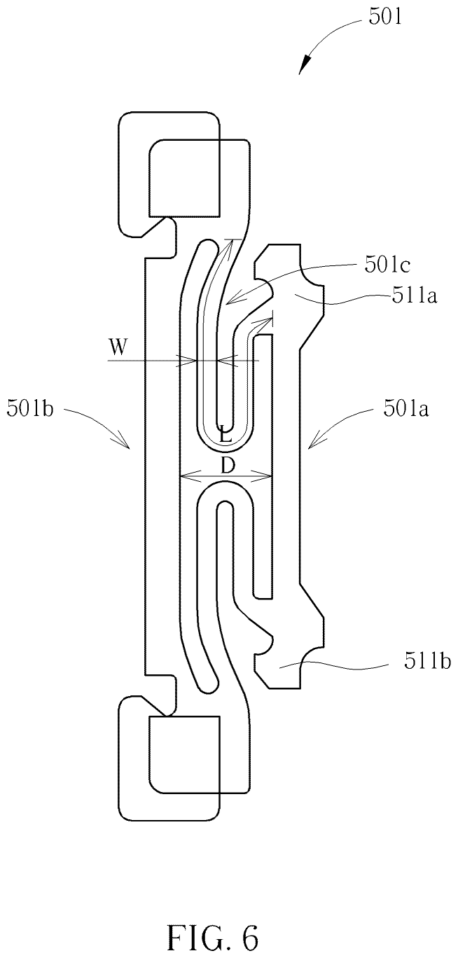

Please also refer to FIG. 6, which shows the length L, width W and distribution distance D of the cantilever of the damper. As shown in FIG. 6, the length L of the cantilever 501c refers to the length of the cantilever 501c extending between the first end 501a and the second end 501b, and the cantilever distribution distance D refers to the area width between the first end 501a and the second end 501b where the serpentine or curved cantilever 501c is distributed. According to an embodiment of the present invention, taking a cantilever width of 0.45 mm as an example, a ratio of the cantilever length L to the cantilever distribution distance D ranging between 2-15 is required.

According to an embodiment of the present invention, the yoke 303 has a central opening 303t. For example, the central opening 303t may be a long and narrow through hole extending along the long axis direction of the yoke 303, which runs through the entire thickness of the yoke 303, but is not limited thereto. By providing a central opening 303t in the yoke 303, the vibration characteristics can be adjusted. For example, a larger central opening 303t can be formed to reduce the overall weight of the yoke 303. In some embodiments, the central opening 303t can be filled with different materials to achieve different vibration effects. In some embodiments, elastic materials, such as foam or rubber, can be placed in the central opening 303t to avoid collision with other components or a casing during operation. According to an embodiment of the present invention, one end of the central opening 303t may be covered by the main magnetic portion 301 fixed on the yoke 303. According to some embodiments of the present invention, the bottom 303b of the yoke 303 may not be provided with any openings.

According to an embodiment of the present invention, the yoke 303 is connected to the frame 10 only through a one-piece and integrally formed elastic member 60. Therefore, the yoke 303 itself is not in direct contact with the frame 10, thereby forming a second suspension system on the other end of the frame 10.

According to an embodiment of the present invention, the elastic member 60 may be a ring structure, which is arranged around the yoke 303. According to an embodiment of the present invention, the elastic member 60 may be a continuous ring structure or a discontinuous ring structure. According to an embodiment of the present invention, for example, the elastic member 60 may be made of elastic materials such as metal sheets, plastic sheets, rubber sheets, or paper sheets. According to an embodiment of the present invention, for example, the elastic member 60 may include iron, stainless steel, aluminum and other metals, but is not limited thereto. According to an embodiment of the present invention, for example, the elastic member 60 may include polymer materials such as polyethylene naphthalate (PEN), polyethylene terephthalate (PET), polyimide (PI), etc., but not limited thereto.

According to an embodiment of the present invention, as shown in FIG. 2 to FIG. 4, the elastic member 60 may include an inner ring structure 601, which may be directly connected and fixed on the periphery of the first surface S1 of the bottom 303b of the yoke 303 by using adhesive. The main magnetic portion 301 is glued and fixed on the second surface S2 opposite to the first surface S1 of the bottom 303b of the yoke 303. According to an embodiment of the present invention, the inner ring structure 601 may be a continuous ring structure or a discontinuous ring structure. According to an embodiment of the present invention, the elastic member 60 may include an outer ring structure 602, which may be directly connected to the bottom surface S0 of the frame 10 by using adhesive. According to an embodiment of the present invention, the outer ring structure 602 may be a continuous ring structure or a discontinuous ring structure. According to an embodiment of the present invention, the first surface S1 of the bottom 303b of the yoke 303 may be substantially coplanar with the bottom surface S0 of the frame 10.

According to an embodiment of the present invention, the elastic member 60 may include a cantilever 603 distributed between the inner ring structure 601 and the outer ring structure 602. The inner ring structure 601 and the outer ring structure 602 are only connected through the cantilever 603. In other words, except for the cantilever 603, the area between the inner ring structure 601 and the outer ring structure 602 is a hollow part. According to an embodiment of the present invention, as shown in FIG. 4, the width W1 of the elastic member 60 across the yoke 303 and the frame 10 is greater than the width W2 of the surround 202 of the drum paper 20 to provide a more stable suspension function.

As shown in FIG. 2, the linear distance between the relative joints of the cantilever 603 of the elastic member 60 between the inner ring structure 601 and the outer ring structure 602 is d, and the actual length between the relative joints of the cantilever 603 of the elastic member 60 between the inner ring structure 601 and the outer ring structure 602 is l, wherein l/d is about 1 to 3. By adjusting the L/D ratio, the strength of the elastic member 60 and the stability during vibration can be improved.

As shown in FIG. 3, for example, the inner ring structure 601 of the elastic member 60 is a continuous ring structure, while the outer ring structure 602 is discontinuous. The outer ring structure 602 includes two connecting portions 602c parallel to the long sides of the inner ring structure 601. The two ends of the inner ring structure 601 are not surrounded by the outer ring structure 602 and are open. The elastic member 60 has four cantilevers 603, and each cantilever 603 can bend and extend from the long side 601b of the inner ring structure 601 to the connecting portion 602c of the outer ring structure 602. Although the elastic member 60 in FIG. 3 has four exemplary cantilevers 603, those skilled in the art should understand that the elastic member in FIG. 3 is only for illustration, and the shape of the elastic member 60 and the number of cantilevers can be adjusted depending on actual needs.

According to an embodiment of the present invention, the elastic member 60 is an integrally formed structure, for example, may be stamped from a single metal sheet or a plastic sheet, but is not limited thereto. According to an embodiment of the present invention, as shown in FIG. 4, the periphery of the bottom 303b of the yoke 303 is provided with an annular recessed structure 303r, forming an annular third surface S3 of the bottom 303b, which is lower than the first surface S1 of the bottom 303b of the yoke 303, thereby providing a buffer space R between the annular recessed structure 303r and the elastic member 60 in order to prevent the elastic member 60 from colliding with the bottom 303b of the yoke 303 during vibration.

According to an embodiment of the present invention, a positioning recess 602r can be provided on the outer ring structure 602 of the elastic member 60, and corresponding to the positioning recess 602r, a positioning protrusion 10r can be provided on the frame 10 to facilitate the positioning during assembly, improve the assembly efficiency, and make the elastic member 60 more stable during operation. According to an embodiment of the present invention, the length of the cantilever 603 of the elastic member 60 can be adjusted to achieve the desired vibration effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A micro-speaker device, comprising:
a frame;
a drum paper comprising a diaphragm and a surround, and the diaphragm is flexibly connected to one end of the frame via the surround, thereby forming a first suspension system;
a magnetic structure comprising a main magnetic portion and a yoke covering and surrounding the main magnetic portion, wherein a magnetic gap is provided between the main magnetic portion and a folded portion of the yoke;
a voice coil sleeved on an outer periphery of the main magnetic portion and penetrates into the magnetic gap, wherein one end of the voice coil is fixedly connected to the diaphragm;
at least one damper flexibly connecting a bottom of the voice coil and a bottom surface of the frame; and
a one-piece elastic member flexibly connected to a first surface of a bottom of the yoke and the bottom surface of the frame, thereby forming a second suspension system.

2. The micro-speaker device according to claim 1, wherein the at least one damper comprises a first end, a second end and a cantilever connecting the first end and the second end.

3. The micro-speaker device according to claim 1, wherein a ratio (L/D) of cantilever length L to cantilever distribution distance D is between 2 and 15.

4. The micro-speaker device according to claim 2, wherein a voice coil lead is fixed to a welding portion of the first end of the at least one damper through electronic spot welding and is electrically connected to circuit on the at least one damper and connection terminals on the second end of the at least one damper.

5. The micro-speaker device of claim 1, wherein the yoke has a central opening.

6. The micro-speaker device according to claim 5, wherein the central opening is a long and narrow through hole extending along a long axis direction of the yoke, and the central opening penetrates through an entire thickness of the yoke.

7. The micro-speaker device according to claim 5, wherein an elastic material is provided in the central opening.

8. The micro-speaker device according to claim 7, wherein the elastic material comprises foam or rubber.

9. The micro-speaker device according to claim 5, wherein one end of the central opening is covered by the main magnetic portion fixed on the yoke.

10. The micro-speaker device according to claim 1, wherein no openings are provided at the bottom of the yoke.

11. The micro-speaker device according to claim 1, wherein the first surface is coplanar with the bottom surface of the frame.

12. The micro-speaker device according to claim 1, wherein a width of the one-piece elastic member is greater than a width of the surround.

13. The micro-speaker device according to claim 1, wherein the one-piece elastic member is an integrally formed structure.

14. The micro-speaker device according to claim 13, wherein the one-piece elastic member is an annular structure.

15. The micro-speaker device according to claim 14, wherein the one-piece elastic member is a continuous annular structure.

16. The micro-speaker device according to claim 14, wherein the one-piece elastic member is a discontinuous annular structure.

17. The micro-speaker device r according to claim 13, wherein the one-piece elastic member is composed of a metal sheet, a plastic sheet, a rubber sheet or a paper sheet.

18. The micro-speaker device according to claim 13, wherein the one-piece elastic member comprises an inner ring structure, an outer ring structure, and a cantilever connecting the inner ring structure and the outer ring structure.

19. The micro-speaker device according to claim 18, wherein the inner ring structure is directly connected and fixed to a periphery of the first surface.

20. The micro-speaker device according to claim 19, wherein the main magnetic portion is fixed on a second surface of the bottom of the yoke opposite to the first surface.

21. The micro-speaker device according to claim 20, wherein an annular recessed structure is provided around the bottom of the yoke to form an annular third surface of the bottom, which is lower than the first surface, thereby providing a buffer space between the annular recessed structure and the one-piece elastic member.

22. The micro-speaker device according to claim 18, wherein the outer ring structure is provided with a positioning recess, and corresponding to the positioning recess, the frame is further provided with a positioning protrusion to facilitate the positioning during assembly.

23. The micro-speaker device according to claim 18, wherein a linear distance between relative joints of the cantilever between the inner ring structure and the outer ring structure is d, and an actual length between the relative joints of the cantilever between the inner ring structure and the outer ring structure is l, wherein l/d is about 1 to 3.
